(19) United States
(12) Patent Application Publication
(10) Pub. No.: US 2015/0373768 A1
(43) Pub. Date: Dec. 24, 2015

(54) METHODS CIRCUITS DEVICES SYSTEMS AND ASSOCIATED COMPUTER EXECUTABLE CODE FOR BRIDGING AUDIO AND DATA COMMUNICATION SESSIONS

(71) Applicant: David Cohen, Herzeliya (IL)

(72) Inventor: David Cohen, Herzeliya (IL)

(21) Appl. No.: 14/461,464

(22) Filed: Aug. 18, 2014

Related U.S. Application Data
(60) Provisional application No. 62/014,188, filed on Jun. 19, 2014.

(51) Int. Cl. H04W 76/02; H04L 29/06; H04W 92/02

(52) U.S. Cl. CPC H04W 76/026; H04W 92/02; H04L 65/4007

(57) ABSTRACT

Disclosed are methods, circuits, device, systems and associated computer executable code for providing digital and/or interactive service to a communication device. According to some embodiments, there is provided a system for providing a digital service on a mobile communication device, such that the system may include a dial pad or dialer interception module to detect a phone number dialed at the mobile communication device. A lookup module may check whether the detected number is associated with a digital service and may retrieve digital service initiation parameters associated with an associated digital service.

### FIELD OF THE INVENTION

The present invention relates generally to the field of communications. More specifically, the present invention relates to methods, circuits, devices, system and associated computer executable code for providing digital services, optionally by bridging an audio communication session with a data communication session.

### BACKGROUND OF THE INVENTION

Almost all of the mobile phones produced today include both voice and data communication capabilities and are generally referred to as smartphones. The smartphone is becoming the main device used to access the Internet and online services. Although a significant portion of the developed world's population is becoming accustomed to managing many of its services online, voice calls are still a dominant mode of communication when it comes to inquiring about and ordering goods and/or services. Voice calls are also used to report problems and request corrective measures. Leveraging of the dual communication modalities available on communication devices to providing synergistic interaction between voice calls and digital services is, however, for the most part still unavailable.

### SUMMARY OF THE INVENTION

The present invention includes methods, circuits, devices, systems and associated computer executable code for providing or otherwise facilitating digital and/or interactive services, for example to a communication device such as a mobile communication device. The present invention may also include methods, circuits, devices, systems and associated computer executable code for associating and optionally synchronizing voice and data communication sessions. According to some embodiments, a voice call between a communication device, such as a smartphone, and a telephonic appliance, such as for example an Interactive Voice Response (IVR) appliance or Call/Support Center Station associated with a service provider, may trigger a digital service to the communication device. The digital service may include digital and/or multimedia content provided to the mobile communication device, and the digital service may include an interactive service triggered and/or otherwise guided by a computer, computing device, computing platform or computer system functionally related to the called service provider. For example, according to embodiments, a conventional voice call from a smartphone running software according to embodiments of the present invention to a telephonic appliance associated with a service provider having a computational device or platform according to the present invention may enable the computing device functionally associated with the service provider to gain digital access to one or more applications running on the smartphone and to perform actions including but not limited to: (1) pushing content for audio rendering (i.e. speaker) circuits and/or video rendering (i.e. display) circuits on the smartphone, (2) controlling one or more services and/or applications installed on the cellphone, (3) installing one or more services and/or applications onto the smartphone, (4) accessing and extracting data from the smartphone, and (5) configuring and/or reconfiguring service and/or application of the smartphone.

Computational platforms or systems, including computational devices and optionally data network communication devices, adapted to access and provide digital services to a communication device in accordance with embodiments of the present invention may be referred to as a Digital Service Bridge (“DSB”). A DSB may be implemented within or otherwise functionally associated with a computer workstation of a service provider (e.g. customer service representative computer workstation), such that an operator of the workstation may trigger and/or guide a digital, optionally interactive, service provided to a communication device in accordance with embodiments of the present invention. A DSB may also be implemented within or otherwise functionally associated with an autonomously operating computer platform such as a computer server and/or an Interactive Voice Response System (IVR), such that the triggering and/or guidance of a digital, optionally interactive, service provided to a communication device in accordance with embodiments of the present invention may be automatic in accordance with computer executable instructions and optionally responsive to inputs provided by a user of the communication device. The DSB may be implemented as part of a distributed architecture such that a networked DBS appliance integral or functionally associated with a service provider's telephony/data network(s) provides either operator workstations or automated servers/IVR's digital service connectivity to a communication device in accordance with embodiments. The DSB may even be implemented as a service or application on a mobile communication device called by the communication device to receive digital service.

Network access to the communication device and its resources and applications may be provided in accordance with several different methodologies. According to some embodiments, a voice call made from a mobile communication device, such as a smartphone, may trigger generation of a digital access token, access data string and/or other access indicator (hereinafter referable to as “access token”) which may be usable by an external computing device, such as a DSB associated server or workstation, in order to gain digital access to the mobile communication device and to interact with one or more resources, services and/or applications running on the mobile communication device. The access token may either be directly transmitted over a distributed data network (e.g. mobile data network) to a specific external device or may be stored in a networked token repository or cache which is accessible by any one of a set of possible external computing devices through a network such as the Internet. According to embodiments, each access token may include or otherwise be linked to a phone identifier (e.g. phone number, etc.) of the mobile device which either generated or otherwise triggered generation of the access token. The token may also include credentials for accessing the communication device. The token may also include encryption keys and/or parameters for accessing the communication device. The token may also include network addresses and/or network parameters for accessing the communication device. Accordingly, a voice-call made from a mobile communication device to a telephonic appliance associated with a DSB according to embodiments may facilitate, via generation and/or transfer or the access token, a communication data link between an external computing device (e.g. DSB) functionally associated with the telephonic appliance and a resource, service and/or application installed on the mobile communication device.

A communication device according to embodiments may include computer executable code running in operating memory of the communication device, which code may include a dial pad module, a dial pad detection or interception module and/or a dialed number detection/interception module adapted to determine which phone number is being dialed by a user of the communication device. A lookup module of the computer executable code may determine whether a dialed number is associated with a called service provider having telephonic appliances with session bridging and/or digital access capabilities according to embodiments of the present invention. A token provider module of the computer executable code on the mobile communication device may provide an access token by: (a) generating one, (b) selecting one from a token storage, (c) modifying an existing stored access token, and/or (d) causing another application either running on the communication device or on a functionally associated server to perform any one or more of (a) through (c). An access token according to embodiments may be a provisional access token including data which may define which resources on the mobile communication device may be accessed. The provisional access token may further include data indicating a period of time, or a window of time, during which access to one or communication device resources may be granted. Additionally, the access token may be encrypted using a public encryption key of an intended user of the access token, thereby limiting use of the token to parties having a corresponding private encryption key.

An access token according to embodiments may include various parameters required to establish a network connection to a mobile communication device connected to the public Internet through a mobile communication network. The access token may include such parameters as the communication device's current public IP address and/or port numbers being monitored by and/or being routed to the mobile communication device. The access token may include a mobile device ID used by an application on the mobile communication device when registering itself on a gatekeeper server. According to further embodiments, the access token may include credentials and/or digital keys for gaining access to one or more resources and/or applications running on the mobile communication device. Whether connecting to a given mobile communication device directly or via a gateway, an application running on an external computing device, such as a DSB and/or functionally associated device, may use an access token associated with the given communication device to gain access to one or more resources and one or more applications on the given communication device, thereby enabling the external computing device application to provide content and/or interactive services to the given mobile communication device.

The lookup module, upon receiving a detected dialed phone number. may access, reference and/or retrieve from either an internal or externally stored data table or database information for call/service providers with digital/interactive service equipment and/or capabilities according to the present invention. Included with or otherwise linked to each provider's record(s) may be a network (e.g. IP) address for the provider and possibly a public encryption key corresponding to a private encryption key used by the provider. A provider's network address may be used in order to transmit an access token directly to the provider. A provider's public encryption key may be used to encrypt an access token and thus limit use of a token to the provider whose public encryption key was used.

It should be clear that any function mentioned as being performed by computer executable code on the communication device may likewise be performed by an application running on a networked computing platform communicatively coupled to the mobile communication device for which the token is generated. It should likewise be clear that any functionality described as being performed by one functional element associated with the digital service or digital interactive service provider may be performed by any number of other networked appliances programmed to perform that function.

According to some embodiments, there may be provided service provider equipment which may include or more of the following: (1) telephonic appliances or equipment adapted to receive one or more voice calls from one or more communication devices; (2) call handling equipment adapted to derive from at least some of the calls a communication device identifier of the calling device, for example a calling mobile communication device's phone number; (3) networked computing devices or platforms adapted to utilize a derived communication device identifier associated with a received voice call to receive, look for and/or optionally retrieve an access token of the communication device which launched the received voice call; (4) network computing devices or platforms adapted to utilize retrieved access tokens in gaining access to the communication device which launched the received voice call; and (5) network computing devices or platforms adapted to gain access to the communication device which launched the received voice call without the use of a token. Any combination of the above listed equipment, whether embodied as a discrete device or set of devices, or whether embodied as code running on multipurpose computing devices or platforms, may be referred to as a digital service bridge (“DSB”).

According to further embodiments, there may also be provided call routing equipment adapted to route received voice calls along with corresponding identifiers and/or with retrieved access tokens to: (1) a service representative (e.g. CRM) workstation, (2) a call waiting queue, and/or (3) an interactive voice response system having digital service capabilities according to embodiments of the present invention. According to embodiments, a service provider's workstation and/or an IVR may either include and/or be functionally associated with a networked computing device or platform, such as a DSB, adapted to facilitate through a network such as the Internet a digital and/or interactive service(s) for a communication device, optionally using an access token associated with the communication device. The digital/interactive service(s) may be substantially automated and driven by a software application running on the external computer device or platform. The digital/interactive service(s) may be manually guided by a human operator of a service provider workstation. The digital/interactive service may include both automatically and manually triggered digital interactions between the service provider and the communication device.

There may be provided an online registry server where a computing device associated with a service provider according to embodiments of the present invention may register information to indicate to a communication device that the service provider is able to provide a digital service according to embodiments. The information stored for a given service provider may be useable by a communication device to facilitate a digital service between the service provider and the communication device. The registry may receive from a service provider and store information useable to generate and or provide an access token for the specific provider. A record or records for a provider may include information such as: (1) a given provider's public encryption key, (2) a given provider's network address and parameters to which access tokens may be directly transmitted and/or saved for subsequent retrieval, and (3) parameters required by the given provider for integration into the access token, for example the mobile communication device's identifier and/or MAC address. The registry may receive from a service provider and store information, such as network addresses and protocols, useable by a communication device to locate and access network gatekeeper servers and/or network gateways through which the service provider may initiate a digital service to the communication device. The online registry server may be accessed by a lookup module of a communication device according to embodiments.

The communication device may access a networked gatekeeper server adapted to mediate a communication link between the communication device and a DSB of interest. The gatekeeper server network location and access protocols may be predefined in software running on the communication device, or may be defined in a registry record accessed by the communication device. A service provider's DSB may also communicate with the gatekeeper, continuously or in response to receiving a voice call from the communication device. The gatekeeper may mediate a digital service connection between the communication device by providing each with the other's relevant network address information and session initiation parameters. Once a direct data connection between the communication device and the service provider DSB is mediated by the gatekeeper, the gatekeeper may terminate communication with the communication device and optionally with the service provider DSB, and the DSB may provide a digital service to the communication device via the direct data connection.

The communication device may access a networked gateway adapted to bridge and/or support a communication link between the communication device and a DSB of interest. The gateway network location and access protocols may be predefined in software running on the communication device, or may be defined in a registry record accessed by the communication device. A service provider's DSB may also communicate with the gateway, continuously or in response to receiving a voice call from the communication device. The gateway may connect a digital service connection between the communication device and the DSB by providing each with the relevant session initiation parameters. The gateway may maintain communication with and between the communication device and the service provider DSB during a digital service session.

According to some embodiments, a communication device may transmit, over a secure encrypted data link, an access token to either a predefined server of a given service provider or to a server identified within a registry record for the given service provider. The access token may be generated by the communication device or by another device functionally associated with the communication device. The token may be based on or derived from an existing reference token, or it may be generated specifically for a specific digital service session with the given service provider. Access tokens may include such parameters as a service provider identifier, a session time window identifier, one or more communication device resource access identifiers or credentials, a session identifier and/or any other identifiers which may uniquely identify and distinguish the token from other tokens.

A communication device according to embodiments may generate or trigger the generation of an access token for a specific service provider and/or for a specific digital service session with the specific service provider, and may transmit the token directly to a network address specifically associated with the service provider and/or the service provider's DSB. According to further embodiments, a token may be transmitted to an online token repository accessible by the service provider's network equipment, for example the provider's DSB.

According to embodiments, there may be provided an online token repository in which an access token generated by or for a communication device according to embodiments may be deposited for subsequent retrieval by computational equipment of one or more service providers, for example by a DSB functionally associated with the service provider. An access token, provisional or otherwise, may be deposited by a mobile communication device which has, is or will be engaged in a voice call with a service provider according to embodiments of the present invention. A deposited token may include or be otherwise linked with an identifier of the mobile communication device which caused the token to be generated and/or deposited. Optionally, a deposited token may include an indicator for which service provider it is intended. According to further embodiments, a deposited token may further include an indicator of the token's useful, valid and/or non-expired, time period(s) during which the token may be accepted by the communication device with which it is associated in order to gain access to that communication device, it's applications and/or resources. Regardless of whether an access token is transmitted directly to a service provider or retrieved by the provider from a repository, the networked computational device or platform functionally associated with the service provider's telephonic equipment may use the information contained in the token to try to establish a direct networked connection with the communication device and to provide digital services to the communication device such as content and/or interactivity.

A DSB according to embodiments of the present invention may include a data communication module adapted to transmit data to, and optionally to receive data from, a communication module of a communication device such as a mobile communication device. Data exchanged between the mobile communication device and the DSB of the service provider may facilitate digital services to the communication such as pushed digital content (e.g. audio and video), and/or configuration, definition, triggering and/or directing of interactive service to the mobile communication device. The interactive services which may be provided according to embodiments of the present invention may include but are not limited to: (1) inquiring with regard to one or more goods or services, (2) requesting or ordering one or more goods or services, (3) making account related inquiries, (4) arranging bill payments, and/or (5) reporting service problems.

According to embodiments, pushed digital content may include entertainment or advertising content pushed to a caller's cellphone while they are waiting for a customer service representative. According to further embodiments, a service provider may push cross-marketing content to a caller while they are waiting in queue. According to yet further embodiments, a service provider may have or be associated with an online advertisement marketplace for advertisers bidding to push ads to people waiting on their phones for service.

According to further embodiments, a communication device with a dial pad module and lookup module according to embodiments may run software adapted to solicit, store and provide feedback in connection with a dialed number. The application may check an online reviews database to which user may provide comments or reviews in connection with good and/or services provided via a given phone number. Phone number associated comments may include: (1) likes or dislikes, (2) quality of service rating, (3) pricing related information, (4) reliability related information, and/or (5) any other information which may be relevant for a potential customer or client when deciding whether to transact business with a business to which the number is associated. Comments, reviews and/or statistics characterizing the reviews (e.g. pricing, QOS, reliability, etc.) may be presented on the communication device screen as the number is dialed. The software may also allow the communication device user to provide and post their comments and/or reviews to the database.

According to further embodiments, the software may check whether any of the comments or reviews on the database, associated with a specific number, where provided by a contact of the communication device user, and may indicate so to the user. This may be achieved by correlating records on the communication device's contacts list with numbers associated with provided comments/reviews. The software may provide instant communication or messaging facilities between two or more users of the software, optionally between a person dialing a given number and another person who previously posted a review in connection with the given number.

According to some embodiments, the DSB or an associated IVR of a provider may be configured to, upon receiving a call from a communication device, send an SMS or other message format to the communication device, which message may include a link to a server where software according to embodiments may be downloaded. The link may be to an application marketplace, such as the App Store or google play store, or may be to a dedicated download server. The software may include some or all of the modules required to engage in a digital service session according to embodiments. The software may include the interceptor, token generator, lookup module, digital service communication module, and a digital interactive service application manager. Upon clicking the link in the message, the software may install and the communication device may start receiving a digital service from the provider.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a system level diagram illustrating the constituent components, and signal flow there between, of an exemplary system for providing interactive services according to embodiments of the present invention;

FIG. 1B is a flowchart including the steps of an exemplary method executable by a system such as the one illustrated in FIG. 1A;

FIG. 2A is a system level diagram illustrating the constituent components, and signal flow there between, of an exemplary system for providing interactive services according to embodiments of the present invention;

FIG. 2B is a flowchart including the steps of an exemplary method executable by a system such as the one illustrated in FIG. 2A;

FIG. 3A is a system level diagram illustrating the constituent components, and signal flow there between, of an exemplary system for providing interactive services according to embodiments of the present invention;

FIG. 3B is a flowchart including the steps of an exemplary method executable by a system such as the one illustrated in FIG. 3A;

FIG. 4A is a system level diagram illustrating the constituent components, and signal flow there between, of an exemplary system for providing interactive services according to embodiments of the present invention;

FIG. 4B is a flowchart including the steps of an exemplary method executable by a system such as the one illustrated in FIG. 4A;

FIG. 5 is a functional block diagram illustrating exemplary functional modules of a mobile communication device adapted according to embodiments of the present invention;

FIGS. 6A & 6B are functional block diagrams illustrating exemplary functional modules of an interactive session bridge according to embodiments of the present invention; and

FIG. 7 is a functional block diagram of an embodiment of the present invention where a dial pad input interceptor module and associated application are adapted to solicit, store and provide feedback in connection with a dialed number.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined.

According to some embodiments of the present invention, mobile devices may connect with and access data from an enterprise data system over a communication network at some portion of which may be a wireless network. While the term wireless network may technically be used to refer to any type of network that is wireless, the term is most commonly used to refer to a telecommunications network whose interconnections between nodes is implemented without the use of wires, such as a computer network (which is a type of communications network). Wireless telecommunications networks are generally implemented with some type of remote information transmission system that uses electromagnetic waves, such as radio waves, for the carrier and this implementation usually takes place at the physical level or “layer” of the network. (For example, see the Physical Layer of the OSI Model). Various wireless technologies and standards exist, including:

Global System for Mobile Communications (GSM): The GSM network is divided into three major systems which are the switching system, the base station system, and the operation and support system (Global System for Mobile Communication (GSM)). The cell phone connects to the base system station which then connects to the operation and support station; it then connects to the switching station where the call is transferred where it needs to go (Global System for Mobile Communication (GSM)). This is used for cellular phones, it is the most common standard and is used by a majority of cellular providers.

Personal Communications Service (PCS): PCS is a radio band that can be used by mobile phones in North America. Sprint happened to be the first service to set up a PCS.

D-AMPS: D-AMPS, which stands for Digital Advanced Mobile Phone Service, is an upgraded version of AMPS but it is being phased out due to advancement in technology. The newer GSM networks are replacing the older system.

Wireless MAN—metropolitan area network.

Wireless LAN—local area networks.

Wireless PAN—personal area networks.

GSM—Global standard for digital mobile communication, common in most countries except South Korea and Japan.

PCS—Personal communication system—not a single standard, this covers both CDMA and GSM networks operating at 1900 MHz in North America.

Mobitex—pager-based network in the USA and Canada, built by Ericsson, now used by PDAs such as the Palm VII and Research in MotionBlackBerry.

GPRS—General Packet Radio Service, upgraded packet-based service within the GSM framework, gives higher data rates and always-on service.

UMTS—Universal Mobile Telephone Service (3rd generation cell phone network), based on the W-CDMA radio access network.

AX.25—amateur packet radio.

NMT—Nordic Mobile Telephony, analog system originally developed by PTTs in the Nordic countries.

AMPS—Advanced Mobile Phone System introduced in the Americas in about 1984.

D-AMPS—Digital AMPS, also known as TDMA.

Wi-Fi—Wireless Fidelity, widely used for Wireless LAN, and based on IEEE 802.11 standards.

Wimax—A solution for BWA (Broadband Wireless Access) and conforms to IEEE 802.16 standard.

Canopy—A wide-area broadband wireless solution from Motorola.

Free Space Optics (FSO) is a telecommunication technology that uses light propagating in free space to transmit data between two points. The technology is useful where the physical connection of the transmit and receive locations is difficult, for example in cities where the laying of fiber optic cables is expensive. Free Space Optics is also used to communicate between space-craft, since outside of the atmosphere there is little to distort the signal. The optical links usually use infrared laser light, although low-data-rate communication over short distances is possible using LEDs. IrDA is a very simple form of free-space optical communications. Distances up to the order of 10 km are possible, but the distance and data rate of connection is highly dependent on atmospheric conditions.

The present invention includes methods, circuits, devices, systems and associated computer executable code for providing or otherwise facilitating digital and/or interactive services, for example to a communication device such as a mobile communication device. The present invention may also include methods, circuits, devices, systems and associated computer executable code for associating and optionally synchronizing voice and data communication sessions. According to some embodiments, a voice call between a communication device, such as a smartphone, and a telephonic appliance, such as for example an Interactive Voice Response (IVR) appliance or Call/Support Center Station associated with a service provider, may trigger a digital service to the communication device. The digital service may include digital and/or multimedia content provided to the mobile communication device, and the digital service may include an interactive service triggered and/or otherwise guided by a computer, computing device, computing platform or computer system functionally related to the called service provider. For example, according to embodiments, a conventional voice call from a smartphone running software according to embodiments of the present invention to a telephonic appliance associated with a service provider having a computational device or platform according to the present invention may enable the computing device functionally associated with the service provider to gain digital access to one or more applications running on the smartphone and to perform actions including but not limited to: (1) pushing content for audio rendering (i.e. speaker) circuits and/or video rendering (i.e. display) circuits on the smartphone, (2) controlling one or more services and/or applications installed on the cellphone, (3) installing one or more services and/or applications onto the smartphone, (4) accessing and extracting data from the smartphone, and (5) configuring and/or reconfiguring service and/or application of the smartphone.

Computational platforms or systems, including computational devices and optionally data network communication devices, adapted to access and provide digital services to a communication device in accordance with embodiments of the present invention may be referred to as a Digital Service Bridge (“DSB”). A DSB may be implemented within or otherwise functionally associated with a computer workstation of a service provider (e.g. customer service representative computer workstation), such that an operator of the workstation may trigger and/or guide a digital, optionally interactive, service provided to a communication device in accordance with embodiments of the present invention. A DSB may also be implemented within or otherwise functionally associated with an autonomously operating computer platform such as a computer server and/or an Interactive Voice Response System (IVR), such that the triggering and/or guidance of a digital, optionally interactive, service provided to a communication device in accordance with embodiments of the present invention may be automatic in accordance with computer executable instructions and optionally responsive to inputs provided by a user of the communication device. The DSB may be implemented as part of a distributed architecture such that a networked DBS appliance integral or functionally associated with a service provider's telephony/data network(s) provides either operator workstations or automated servers/IVR's digital service connectivity to a communication device in accordance with embodiments. The DSB may even be implemented as a service or application on a mobile communication device called by the communication device to receive digital service.

Network access to the communication device and its resources and applications may be provided in accordance with several different methodologies. According to some embodiments, a voice call made from a mobile communication device, such as a smartphone, may trigger generation of a digital access token, access data string and/or other access indicator (hereinafter referable to as “access token”) which may be usable by an external computing device, such as a DSB associated server or workstation, in order to gain digital access to the mobile communication device and to interact with one or more resources, services and/or applications running on the mobile communication device. The access token may either be directly transmitted over a distributed data network (e.g. mobile data network) to a specific external device or may be stored in a networked token repository or cache which is accessible by any one of a set of possible external computing devices through a network such as the Internet. According to embodiments, each access token may include or otherwise be linked to a phone identifier (e.g. phone number, etc.) of the mobile device which either generated or otherwise triggered generation of the access token. The token may also include credentials for accessing the communication device. The token may also include encryption keys and/or parameters for accessing the communication device. The token may also include network addresses and/or network parameters for accessing the communication device. Accordingly, a voice-call made from a mobile communication device to a telephonic appliance associated with a DSB according to embodiments may facilitate, via generation and/or transfer or the access token, a communication data link between an external computing device (e.g. DSB) functionally associated with the telephonic appliance and a resource, service and/or application installed on the mobile communication device.

According to embodiments, there is provided a system for providing a digital service on a mobile communication device, said system may include a dial pad or dialer interception module to detect a phone number dialed at the mobile communication device. A lookup module may check whether the detected number is associated with a digital service and may retrieve digital service initiation parameters associated with an associated digital service. The system may include a digital service communication module on the mobile communication device, and the module may be adapted to engage in a digital service communication session with, and receive digital service from, a digital service communication module on service provider equipment. Said digital service communication module is adapted to engage in the digital service communication session either directly with the service provider or through a digital service gateway.

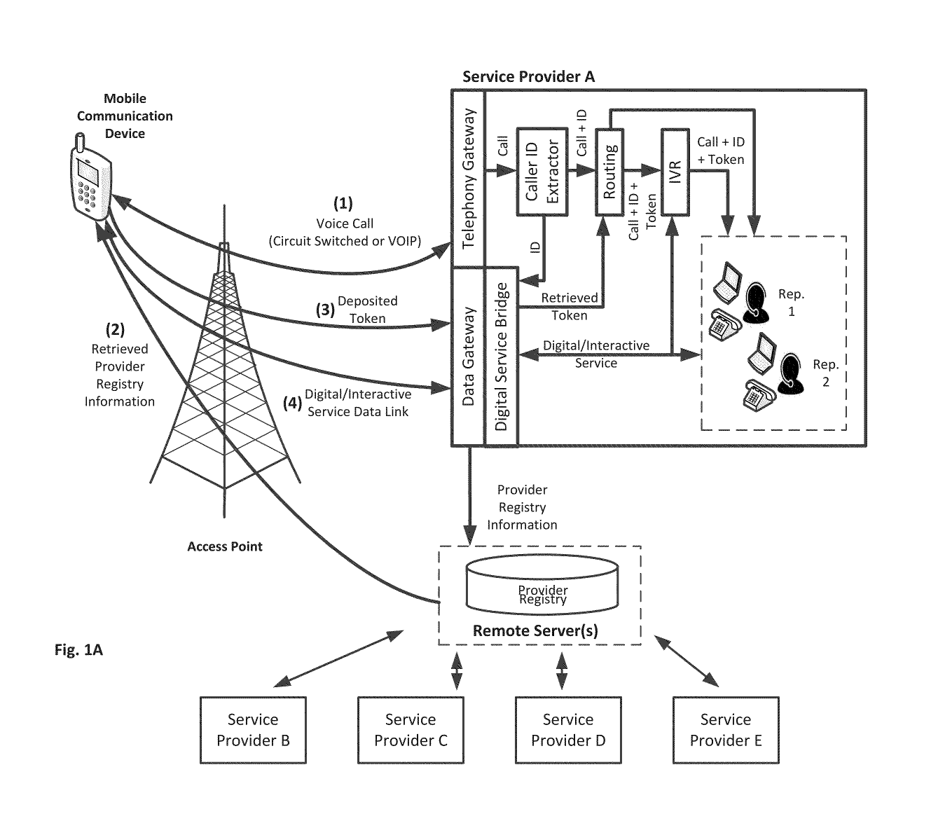

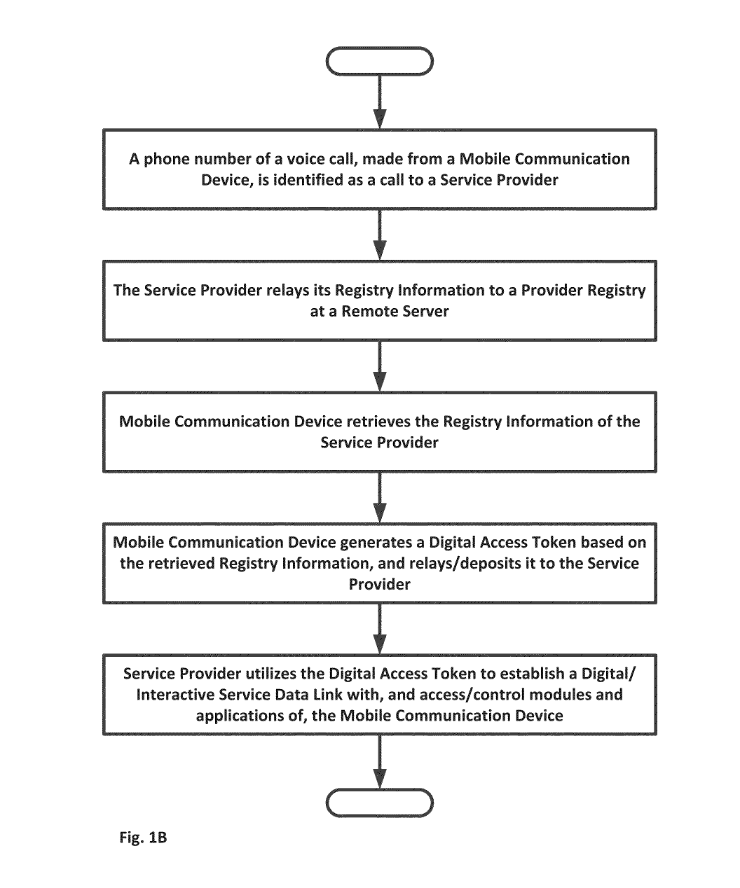

Turning now to FIG. 1A, there is shown a system level diagram illustrating the constituent components, and signal flow there between, of an exemplary system for providing interactive services, wherein an access token generated by a Mobile Communication Device is deposited directly with a corresponding Service Provider. A Mobile Communication Device on a voice call references a Provider Registry, accessible and intermittently updated by Service Provider(s), on a Remote Server(s). If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, communicate it over a data link to a destination provided as part of the retrieved Provider Registry information and deposit it with the respective Service Provider. The Service Provider utilizes the token for establishing a digital/interactive data link with the Mobile Communication Device, and/or for accessing, monitoring, activating or the like one or more Mobile Communication Device software applications and/or hardware components.

In FIG. 1B there is shown a flowchart including the main steps of an exemplary method executable by a system such as the one illustrated in FIG. 1A and described above.

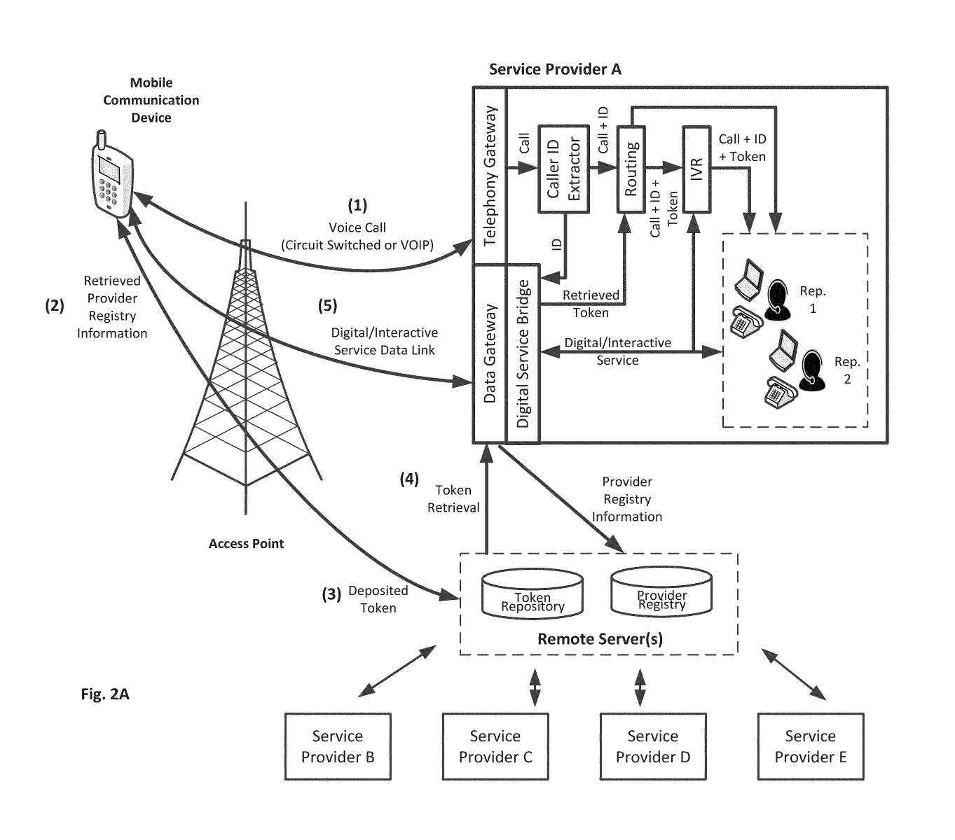

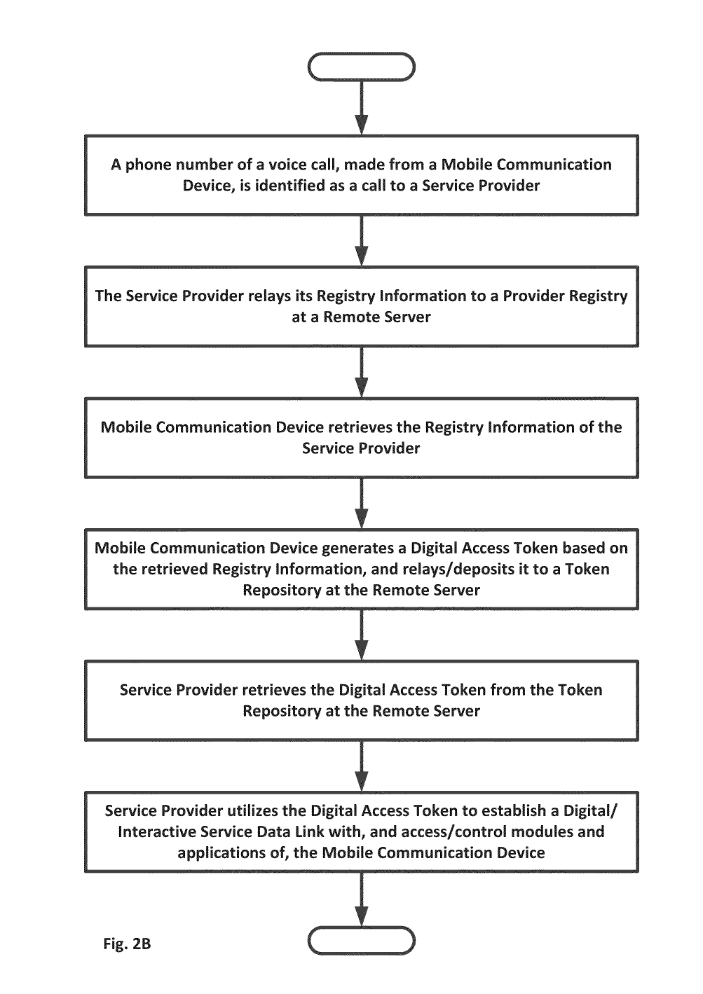

Turning now to FIG. 2A, there is shown a system level diagram illustrating the constituent components, and signal flow there between, of an exemplary system for providing interactive services, wherein an access token generated by a Mobile Communication Device is deposited with a Token Repository for a corresponding Service Provider to retrieve. A Mobile Communication Device on a voice call references a Provider Registry, accessible and intermittently updated by Service Provider(s), on a Remote Server(s). If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, communicate it over a data link, and deposit it with a Token Repository, at a destination known to both the Mobile Communication Device and the respective Service Provider, or at a destination provided as part of the retrieved Provider Registry information. The respective Service Provider retrieves the deposited access token from the Token Repository and utilizes the token for establishing a digital/interactive data link with the Mobile Communication Device, and/or for accessing, monitoring, activating or the like, one or more Mobile Communication Device software applications and/or hardware components.

In FIG. 2B there is shown a flowchart including the main steps of an exemplary method executable by a system such as the one illustrated in FIG. 2A and described above.

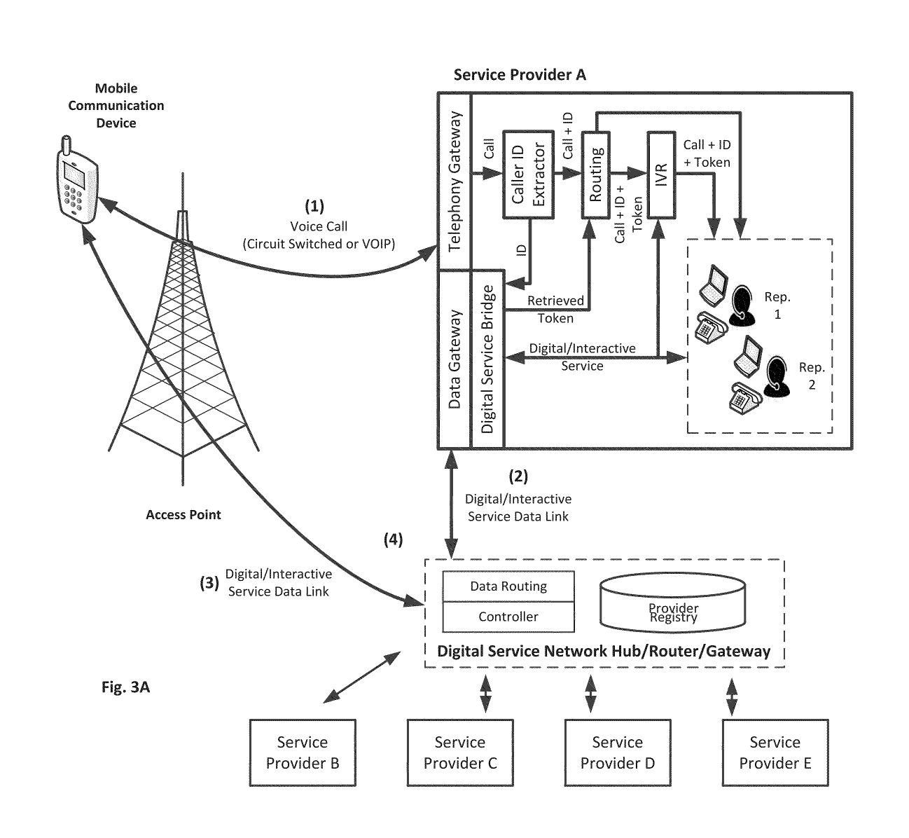

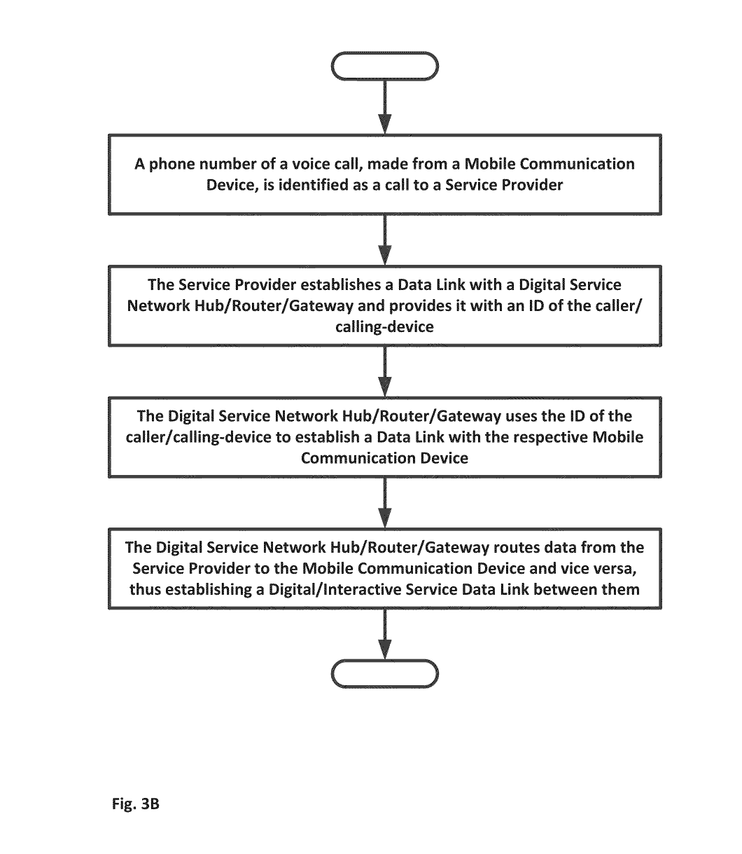

Turning now to FIG. 3A, there is shown a system level diagram illustrating the constituent components, and signal flow there between, of an exemplary system for providing interactive services, wherein the digital service is provided to the communication device through a gateway known to both the communication device and the service provider. An access token generated by a Mobile Communication Device may be communicated to, and deposited with, a corresponding Service Provider through a Digital Service Network Router. A Mobile Communication Device on a voice call references a Provider Registry on a Remote Server(s) functionally associated with a Digital Service Network Router. If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, and communicate it over a data link to the Digital Service Network Router. The Digital Service Network Router utilizes a Data Routing Module to route and communicate the access token, and deposit it with the respective Service Provider, at a destination known to the Digital Service Network Router. The respective Service Provider utilizes the token for accessing, monitoring, activating or the like, one or more Mobile Communication Device software applications and/or hardware components, over a digital/interactive data link with the Mobile Communication Device through, and routed by, the Digital Service Network Router.

In FIG. 3B there is shown a flowchart including the main steps of an exemplary method executable by a system such as the one illustrated in FIG. 3A and described above.

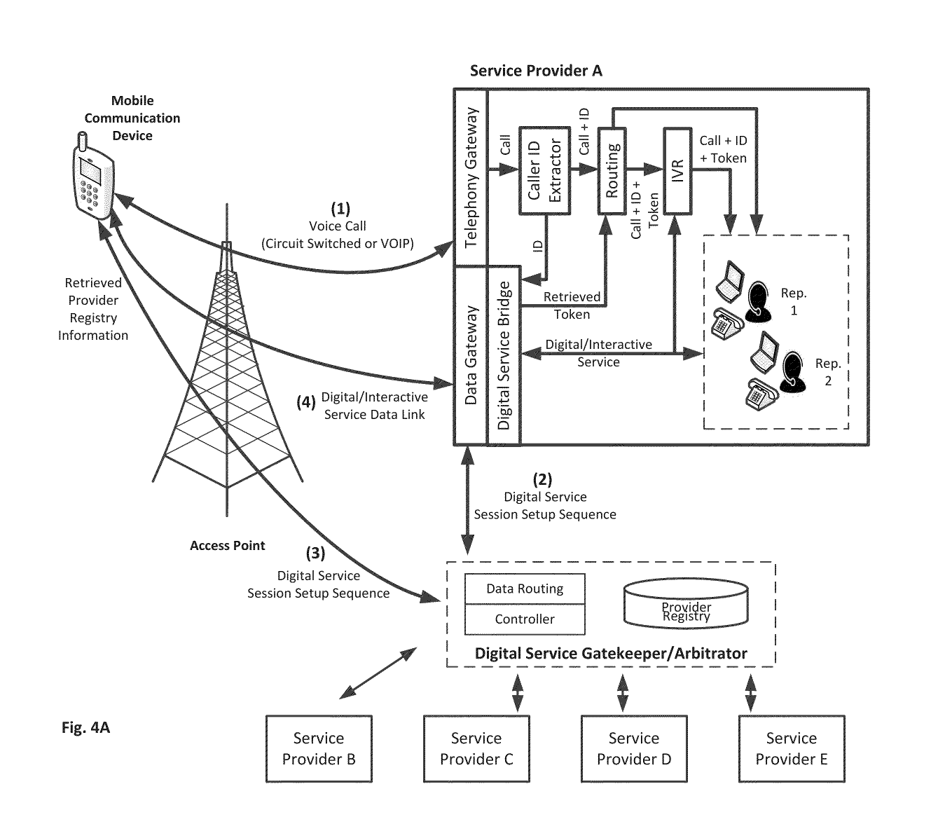

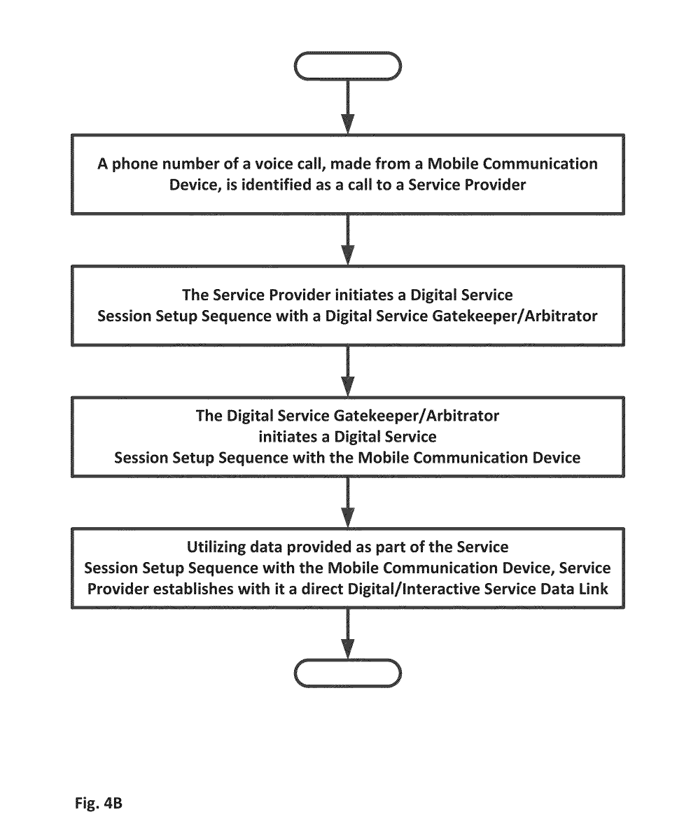

Turning now to FIG. 4A, there is shown a system level diagram illustrating the constituent components, and signal flow there between, of an exemplary system for providing interactive services, wherein a digital service session is established through a gatekeeper which mediates a direct communication session between the communication device and the Digital Service Bridge (DSB). According to embodiments, an access token generated by the mobile communication device is communicated to, and deposited with, a corresponding Service Provider through a Digital Service Gatekeeper. A Mobile Communication Device on a voice call references a Provider Registry on a Remote Server(s) functionally associated with a Digital Service Gatekeeper. If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, and communicate it over a data link to the Digital Service Gatekeeper. The Digital Service Gatekeeper utilizes a Data Routing Module to route and communicate the access token, deposit it with the respective Service Provider, at a destination known to the Digital Service Gatekeeper, and initiate a digital service session setup sequence between the respective Service Provider and the Mobile Communication Device. The respective Service Provider utilizes information generated as part of the digital setup sequence for establishing a direct (not through the Digital Service Gatekeeper) digital/interactive data link with the Mobile Communication Device, and/or utilizes the access token for accessing, monitoring, activating or the like one or more Mobile Communication Device software applications and/or hardware components.

In FIG. 4B there is shown, a flowchart including the main steps of an exemplary method executable by a system such as the one illustrated in FIG. 4A and described above.

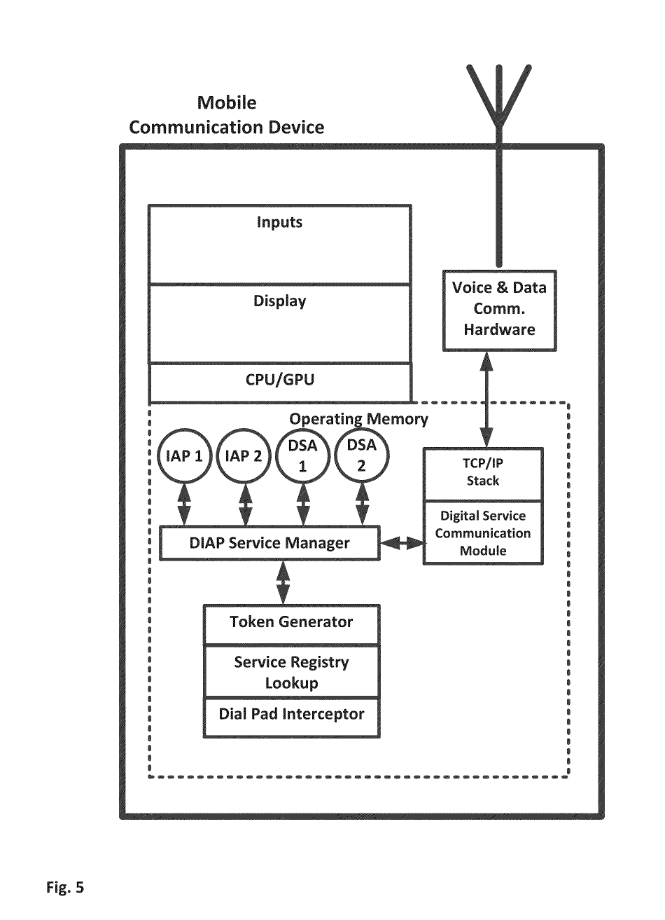

Turning now to FIG. 5, there is shown a functional block diagram illustrating exemplary functional modules of a mobile communication device adapted according to embodiments of the present invention. The device includes a dial pad interceptor, a token generator, a digital service communication module, and a digital service application manager.

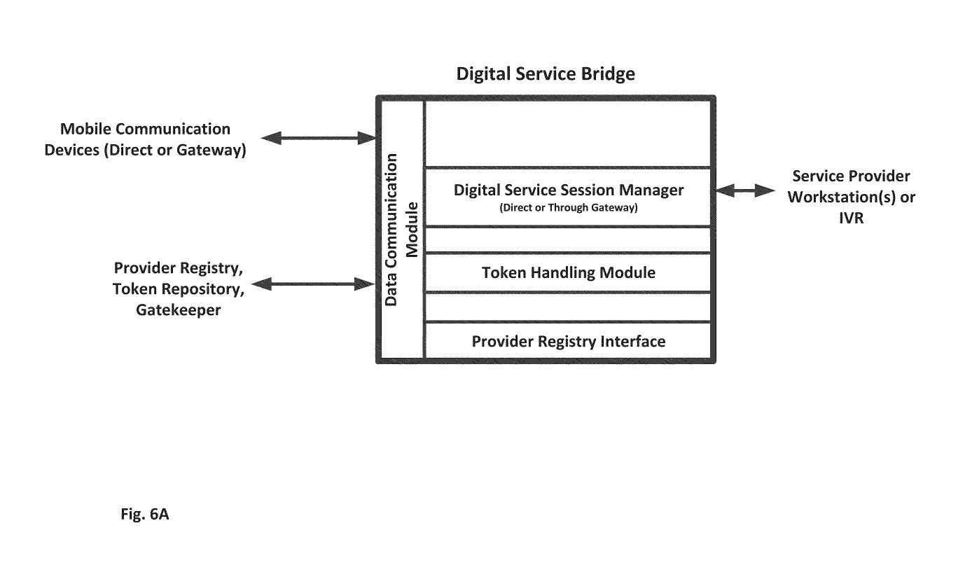

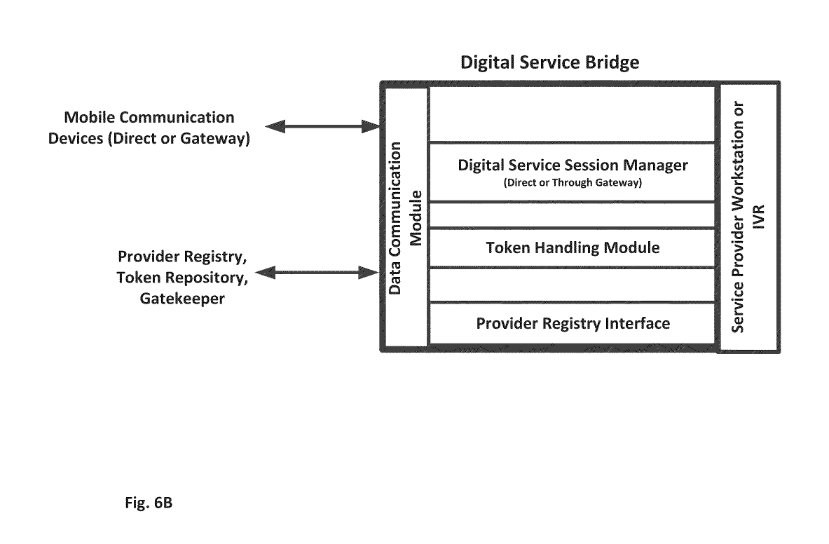

Turning now to FIGS. 6A & 6B, there are shown functional block diagrams illustrating exemplary functional modules of an interactive session bridge according to embodiments of the present invention. FIG. 6A shows an embodiment where the Digital Service Bridge (DSB) is discrete from the workstation, application server and/or IVR which drives the digital service session. FIG. 6B shows an embodiment where the Digital Service Bridge (DSB) is integral with the workstation, application server and/or IVR's which drives the digital service session.

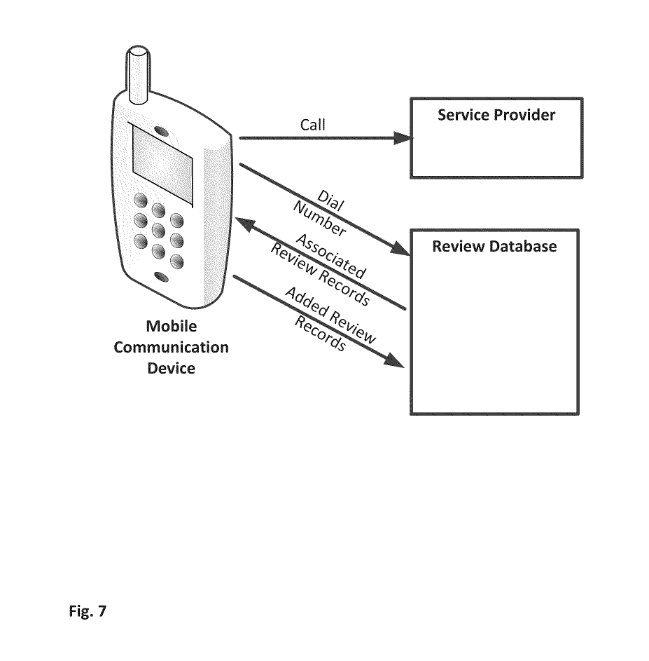

Turning now to FIG. 7, there is shown a functional block diagram of an embodiment of the present invention where a dialer or dial pad input interceptor module and associated application are adapted to solicit, store and provide feedback in connection with a dialed number.

It is to be understood that both the foregoing general description and the following detailed description are exemplary and explanatory only and are not restrictive of the invention, as claimed.

1. A system for providing a digital service on a mobile communication device, said system comprising:
a dial pad or dialer interception module to detect a phone number dialed at the mobile communication device;
a lookup module to check whether the detected number is associated with a digital service and to retrieve digital service initiation parameters associated with an associated digital service.

2. The system according to claim 1, further comprising a digital service communication module on the mobile communication device adapted to engage in a digital service communication session with, and receive digital service from, a digital service communication module on service provider equipment.

3. The system according to claim 2, wherein said digital service communication module is adapted to engage in the digital service communication session either directly with the service provider or a through a digital service gateway.
